(19) United States
(12) Patent Application Publication
(10) Pub. No.: US 2020/0250623 A1
(43) Pub. Date: Aug. 6, 2020

(54) SYSTEMS AND TECHNIQUES TO QUANTIFY STRENGTH OF A RELATIONSHIP WITH AN ENTERPRISE

(71) Applicant: Capital One Services, LLC, McLean, VA (US)

(72) Inventors: Yue DUAN, McLean, VA (US); Ning KONG, McLean, VA (US)

(73) Assignee: Capital One Services, LLC, McLean, VA (US)

(21) Appl. No.: 16/265,989

(22) Filed: Feb. 1, 2019

(51) Int. Cl. G06Q 10/10; G06Q 10/06; G06N 20/00

(52) U.S. Cl. CPC G06Q 10/105; G06N 20/00; G06Q 10/063

(57) ABSTRACT

Disclosed are a system, apparatus and techniques for training a model to account for a relationship depth of an enterprise user with an enterprise. A machine learning engine may evaluate a machine learning model using user-related generalized data drawn from multiple service areas of the enterprise, data sources external to the enterprise, or both as an input or inputs to quantify the relationship depth. A relationship depth value may be generated that is representative of a user a dept.

### BACKGROUND

Enterprises may provide multiple services that are available to users; however, a respective user may utilize only a portion of the available services. The respective user's relationship with one service provider within the enterprise may influence the user to behave differently during other interactions with another service provider within the enterprise. While the enterprise may know details of the user's interactions with each of the provided services, it is difficult to assess a user's relationship with the whole enterprise across all the available services provided by different service providers in the enterprise. Depending on the type of enterprise, such as a retail or financial enterprise, the ability to quantify a relationship may be particularly relevant with regard to anticipating user behaviors, such as, marketing response, pricing sensitivity, profitability, servicing cost, account life and the like.

While some solutions use traditional methods to tackle one aspect of the problem, for example, customer satisfaction, these solutions do not evaluate the users' interactions across multiple services provided by the enterprise. In the type of enterprises that offer multiple services, customer satisfaction measured with respect to a single service does not provide much insight into those customers' relationships with the different aspect of enterprise.

It would be helpful if techniques were available to intelligently assess the relationship between a user and an enterprise by looking at aspects of the users' interactions with the services provided by the enterprise.

### SUMMARY

Disclosed is an apparatus that is communicatively coupled to a plurality of operational systems of an enterprise that provides different services to enterprise users, and includes a memory and an association quantification processing component. The memory stores programming code. The association processing component includes a processor and a machine learning engine. The machine learning engine is coupled to the memory. The association quantification processing component is operable to execute the stored programming code, that when executed causes the association quantification processing component to perform functions. The functions include receiving, from each of the number of operational systems, information related to an enterprise user. Generalized data is extracted from the enterprise user-related information received from each of the plurality of operational systems. The generalized data extracted from the enterprise user-related information received from each respective operational system of the plurality of operational systems is weighted. The machine learning engine may process the weighted generalized data from each respective operational system of the plurality of operational systems. A relative relationship depth value may be generated for the enterprise user based on the processing of the generalized data extracted from the enterprise user-related information received from each operational system of the number of operational systems. The relative relationship depth value may quantify a relationship of the enterprise user with the enterprise.

An example of a method is disclosed. The method includes steps of receiving, by an association quantification processing component, from one or more different operational systems of an enterprise, information related to a number of enterprise users. Generalized data related to each enterprise user of the number of enterprise users is obtaining from the information received from each of the one or more different operational systems. An enterprise user data matrix may be populated with the generalized data obtained from each respective operational system of the one or more different operational systems for each of the enterprise users of the number of enterprise users. A machine learning engine weights the generalized data in the enterprise user data matrix based on the respective operational system of the different operational systems from which the generalized data was obtained. The weighted generalized data according to a machine learning algorithm is processed by the machine learning engine. Based on a result of the processing, a relative relationship depth value is generated for each respective enterprise user of the number of enterprise users. The relative relationship depth value quantifies a relationship of the respective enterprise user of the number of enterprise users with the enterprise.

Also disclosed is a system including a memory, association quantification processing component and a number of enterprise operational systems. The memory stores programming code and enterprise information. The association quantification processing component is configured to generate a relative relationship depth value for a number of enterprise users execution of the programming code stored in the memory. Each of the number of enterprise operational systems provides a service to the number of enterprise users and is coupled to a respective enterprise operational system memory. The memory, the association quantification processing component and the number of enterprise operational systems are coupled in a network via a network bus. The association quantification processing component upon execution of the programming code stored in the memory, the association quantification processing component is configured to perform functions. The functions include requesting, from each of the number of enterprise operational systems, information related to an enterprise user. From each of the plurality of enterprise operational systems, the association quantification circuitry may receive the requested information related to the enterprise user. The association quantification circuitry may obtain generalized data from the received information related to the enterprise user from the received requested information. An enterprise user data vector may be populated with the generalized data obtained from the received information. The enterprise user data vector is related to the enterprise user. A machine learning engine may weight the generalized data based on the specific respective enterprise operational system that provided the generalized data. The machine learning engine processes the weighted generalized data in the enterprise user data vector. Based on the results of the processing by the machine learning engine, a relative relationship depth value is generated for the enterprise user. The relative relationship depth value quantifies a relationship of the enterprise user with respect to services provided by the enterprise.

### BRIEF DESCRIPTION OF THE DRAWINGS

FIG. 1 is an example of an implementation of a system for quantifying an association of a user with an enterprise.

FIG. 2 is an example of a graphic indicating a data flow for input to a machine learning example usable for quantifying the association of a user with an enterprise.

FIG. 3 illustrates an example of a machine learning process that utilizes the quantified association of a user with the enterprise based on the data input from the example of FIG. 2.

FIG. 4 illustrates a general process that encompassing the examples illustrated in FIGS. 2 and 3.

FIG. 5 illustrates an example of a system including an example of association quantifying circuitry as described in the examples of FIGS. 1-4.

FIG. 6 is a flow chart of an example of a process for generating and using a machine-learning model according to some aspects.

### DETAILED DESCRIPTION

Various examples are generally directed to techniques to quantify a strength of a user's relationship with an enterprise based on the user's participation or interaction with the services provided by different service providers within the enterprise. Examples include a system, a method and computer-readable medium that trains a target service model using information and data related to a user's relationship with an enterprise.

Large enterprises often provide multiple lines of commercial products to users (i.e., customers or clients). For example, some financial institutions provide credit card services, banking services, loan services, and investment services (e.g., retirement services and/or products, such as loans, life insurance, or the like). Other types of enterprises may provide affinity services, such as rewards at retailers, gasoline, groceries, or the like, home improvement services, household products (e.g., paint, doors, furnishings, cleaning supplies, or the like), tool rental or other services provided by different organizations within the respective enterprise.

While it may be difficult to assess a customers' relationship with the whole enterprise even though customers may have multiple products and participate in different services, as explained below it may be possible to use machine learning apparatuses and techniques to gain insight into a user's relationship with multiple service providers of a whole enterprise as opposed to only determining a user relationship with one service of a single service provider's relationship as provided by the traditional processes of determining a relationship strength.

Machine learning engines or systems, such as a neural network trained on multiple targets (e.g., proposed service providers or behavioral results) using rich data sources from the different service or product providers (e.g., lines of business) within an enterprise may provide additional insights into a strength of a user's relationship with an enterprise. In a financial institution example, the input variables to a neural network may include customer behavior (e.g. website and mobile app logon activities, enterprise education program enrollment, purchases), account performance (e.g. balance, utilization, payment), and any pertinent context information the institution has about the customer. The neural network may be trained using the same input which, in some examples, may be directed toward multiple target variables including marketing response, risk (charge-off), valuation, churn (e.g., how often a customer changes accounts), and other target variables of interest. In other examples, different inputs to the neural network may be required for different target variables. By training on multiple targets, an understanding of how the same input variables may be affecting different use-related metrics may be attained, and by extracting the latent feature before the output layer of the neural network, a score that quantifies a strength of the user's relationship may be obtained and used in the training of service models to predict the effect of different actions on a user's interaction with the enterprise as a whole.

Reference is now made to the drawings, wherein like reference numerals are used to refer to like elements throughout. In the following description, for purpose of explanation, numerous specific details are set forth in order to provide a thorough understanding thereof. It may be evident, however, that the novel examples can be practiced without these specific details. In other instances, well-known structures and devices are shown in block diagram form to facilitate a description thereof. The intention is to cover all modification, equivalents, and alternatives within the scope of the claims.

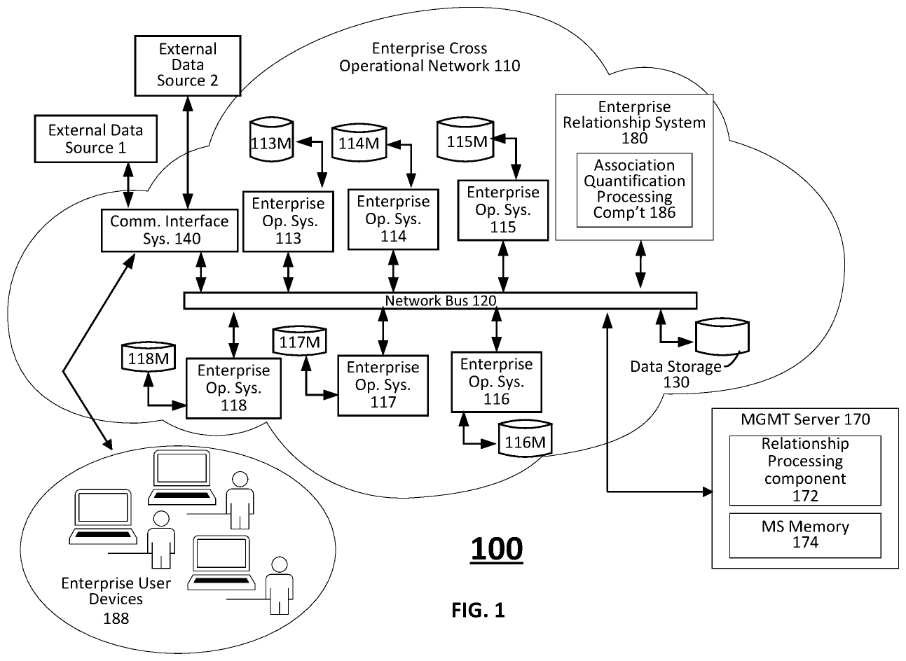

FIG. 1 is an example of an implementation of a system for quantifying an association of a user with an enterprise. An enterprise may be a commercial, governmental, or another type of entity that interacts with and provides services to users (i.e. clients or customers). The type of enterprise referred to in the examples may be a banking or lending entity, or the like. The network system 100 may include an enterprise cross operational network 110, external data source 1, external data source 2, and a management (MGMT) server 170.

The management (MGMT) server 170 may include a management server (MS) memory 174 and a relationship processing component 172. The management server (MS) memory 174 may, for example, store relationship management-related programming code, enterprise-related programming code and other information used to manage one or more processes. The relationship processing component 172 when executing the relationship management-related programming code may select a target enterprise user evaluation process for updating from a number of enterprise user evaluation processes (shown in and described with reference to other examples). An enterprise user evaluation process may be a process for determining a user's likelihood of using, or tendency to use, a service or group of services provided by the enterprise to the enterprise users. The enterprise user evaluation process may be supplemented based on a service model (not shown in this example but discussed with respect to another example) trained with the relative relationship depth value of the enterprise user, such as 188. A service model may be a mathematical function that represents a user's likelihood or tendency to use a particular service or group of services provided by the enterprise.

The enterprise cross operational network 110 may include an enterprise relationship system 180, enterprise operational systems 113-118, a network bus 120, a data storage 130, and a communication interface 140. The enterprise relationship system 180, communication interface 140, the data storage 130, and the enterprise operational systems 113-118 may be coupled in the enterprise cross operational network 110 via a network bus 120.

The enterprise relationship system 180 may include the association quantification processing component 186 and couplings to memory devices (not shown in this example but shown in other examples). The enterprise relationship system 180 may be communicatively coupled to the network bus 120, and to the enterprise operational systems 113-118 and the external data sources 1 and 2. The enterprise relationship system 180 may perform various functions via interactions with one or more of the enterprise operational systems 113-118, and the external data sources 1 and 2.

The network bus 120 may be a parallel or serial data communication bus coupling devices in the network 110 to one another. In some examples, the network bus 120 may couple the association quantification processing component to the number of enterprise operational systems 113-118.

The memory 130 may store programming code and enterprise information, such as network addresses of the enterprise operational systems 113-118, other technical information related to the enterprise, such as, for example, an enterprise user data matrix and enterprise user data vectors (not shown but described in more detail with reference to later examples), and the like.

The number of enterprise operational systems 113-118 may provide services to users via enterprise user devices 188. The services provided by the enterprise operational systems 113-118 may be different but may have some overlap. In a banking or financial example, the services provided may be financial services, credit card services, website activities, bank account services or the like. Other examples may include retail environments, grocery enterprises, or the like. Each of the enterprise operational systems 113-118 may be coupled to a respective enterprise operational system memory, such as 113M-118M. With respect to data for use by the enterprise relationship system 180, the external data sources 1 and 2 may provide other data such as commercial data relevant to the enterprise, macro-economic data, social network-related data or the like.

The communication interface 140 may be a wired or wireless interface that operates according to known communication wired or wireless protocols. The communication interface 140 may be communicatively coupled to and operable to enable the enterprise operational systems 113-118, the association quantification processing component 186, and the management server 170 to communicate with the external data sources 1 and 2 or respective ones of the enterprise user devices 188, and vice versa. Details of an example of a communication interface are described in more detail with reference to FIG. 7.

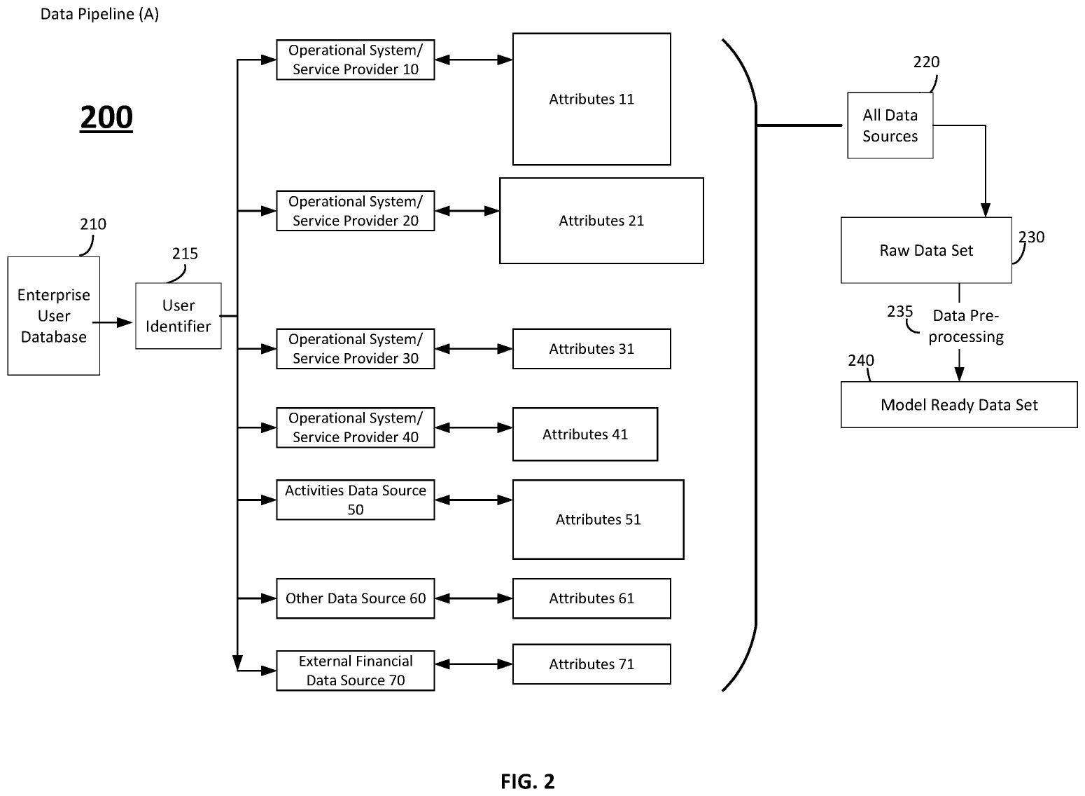

The data flow between the enterprise operational systems 113-118 and FIG. 2 is an example of a graphic indicating a data flow for input to a machine learning example usable for quantifying the association of a user with an enterprise.

The data flow for input into a machine learning algorithm as used herein may be referred to as a data pipeline. Data pipeline 200 may begin with a database of enterprise user data, such as enterprise user database 210. From the enterprise user database 210, a processing device such as the association quantification processing component 186 of the enterprise relationship system 180 may extract a unique enterprise user identifier (ID) 215. The unique enterprise user identifier 215 may be an identifier that is unique to the enterprise only (and is different from account identifiers of the enterprise user) and not to any governmental agency or another enterprise. For example, the enterprise may generate a unique enterprise identifier and assign the unique enterprise identifier to a user as the user's unique enterprise user ID after the user initially requests, or is provided with, a service or a product from an enterprise service provider. The use of the unique enterprise user ID in the examples allows the data to be anonymized by stripping out personal information. For example, any received data may be stripped of any non-public information, and the unique enterprise user ID may be encrypted to fully protect the enterprise user's privacy.

The unique user ID 215 may be used by the service providers, such as service provider 10, service provider 20, service provider 30, or service provider 40, within the enterprise to associate the user with services and products provided by the respective service provider. By using a unique user ID 215 for all the service providers within the enterprise, services can be delivered more quickly and efficiently. The unique user ID 215 also allows the different service providers to use information already provided by the user when setting up a new service provider account. This allows enterprise user-related information associated with the user and specific to the service provider to be shared among the service providers 10-40 and activities data source 50 within the enterprise.

The operational systems/service providers, such as service provider 10, service provider 20, service provider 30, or service provider 40 may be considered rich data sources (e.g., sources with relevant data, which may have to be extracted from the provided information). For example, data related to a user may be obtained from a rich data source (e.g., a data source with relevant data) such as service provider 10, service provider 20, service provider 30, or service provider 40. In the example, generalized data may be extracted from the obtained data. The respective service providers 10-40 may represent services provided by different business entities with an enterprise. The type of information that may be provided by the service providers 10-40, for example, in a financial example, may include a number of accounts, account type, payment history, direct deposit setups, account age, account status (i.e., opened or closed) or the like. Activities data source 50 may also include enterprise user-related information related to an enterprise user's interactions with the systems of the service providers 10-40. Other rich information sources, such as other data source 60 and/or external financial data source 70 may provide information that is not specific to an enterprise user, but that may still be relevant to the enterprise. For example, activities data source 50 may include information related to some respective enterprise user's interactions with the enterprise either through a web browser, telephone, email, chatbot or the like. Collectively, the operational system/service providers 10-40, activities data source 50, other data source 60 and external financial data source 70 may be referred to as “data sources.” The information provided by the additional data sources may be referred to as additional user-related information, which is user-related information for services provided by a respective one of the one or more operational systems, e.g., 10-40 or 50-70. In some examples, the user-related information may be from a single time instance, while in other examples the user-related information may include information obtained at several different times, over different time periods or after certain events (e.g., applying for a credit card, requesting a cash advance, applying for a loan, or the like).

The enterprise relationship system 180 may perform various functions with respect to the service providers and the data associated with the user's unique user ID 215. In an example, the enterprise relationship system 180 may, via the association quantification processing component 186, access, or make a request to, all the service providers' systems of the enterprise for data. The user data may be obtained from one or more of the service providers 10-40, activities data source 50, other data source 60 or the external financial data source 70. Either by accessing the user data via a link to the respective memory coupled to the data source or in response to the request using the user identifier to extract any data related to the user's interaction with the respective service provider, information related to an enterprise user may be received from each of the plurality of operational systems. The other data source 60 may be multiple data sources including external data sources from which the external information, such as commercial data relevant to the enterprise and/or a respective enterprise user may be received. Attributes or parameters may be extracted from each of the respective data sources. For example, attributes 11, 21, 31, 41, 51, 61 and 71 may be enterprise user-related generalized data extracted from the information provided by respective operational systems, such as service providers 10-40, activities data source 50, other data source 60 and external financial data source 70. For example, service provider 10 may be a credit card provider for the enterprise, and the data received from service provider 10 may include attributes 11, which includes credit card-related information, such as a number of accounts, account age, payment history and the like. Other service providers, such as service provider 30 may be directed to credit tracking and may provide attributes 31. The attributes 31 may include enrollment-related generalized data with respect to credit tracking and recent login information.

The other attributes 21 and 41-71 may also include some data. For example, attributes 51 may include generalized data related, for example, to historical login activities of a user, browser types when accessing information from an enterprise website, the language or languages used when accessing the enterprise website, a browsing history with regard of the enterprise (e.g., content that the user navigated to on the enterprise website), an internet protocol (IP) address of the user's computer, a geo-location of the IP address, or the like. In some examples, the generalized data may be based on information related to one or more of credit card accounts, banking account information, credit-related behavior, credit trending, or loan account information. The data pipeline 200 may process the commercial data received from the external data source for input into the machine learning engine as generalized external data. The attributes 11-71 may be generalized data that is extracted from the respective data sources. The generalized data from the various service providers 10-40, activities data source 50, other data source 60 or external financial data source 70 may be merged based on the unique user ID, for example, in a data structure 220, and combined as a raw data set of generalized data 230.

The generalized data 230 may be preprocessed. For example, data preprocessing 235 may account for omissions in some of the data supplied by a respective service, such as operational system/service provider 10 or the like. For example, the system data may include missing indicators between different lines of business within the same enterprise. For example, an indicator may be a birthdate, an address, a payment history, an income or the like. Due to the missing indicator, an analysis of the customer's accounts across the different lines of business may result in an indication of less than acceptable credit behavior by the customer. If the missing indicator cannot be obtained from the customer's records in other business accounts, the system may analyze other records to locate a group of enterprise users that have account information like the customer being analyzed and may use the similar groups account information to “fill in” any information missing from the customer being analyzed. Alternatively, the system may fill in the missing data with a maximum or minimum value depending upon the importance of the data.

Normalization may also occur as part of the data preprocessing 235 to place the generalized data into a common format (e.g., the same value ranges or the like). In addition to normalization, the preprocessing may also account for omissions in the generalized data, such as missing indicators (e.g., income range, gender, marital status or the like), or missing imputations related to the user.

The output of the pipeline data process is a model ready data set 240. The model-ready data set may include, for example, between 50-250 variables for each enterprise user that is being evaluated. Of course, more or less variables for each enterprise user may be used depending upon the granularity, variable overlap and other considerations related to the quality and/or quantity of the generalized data.

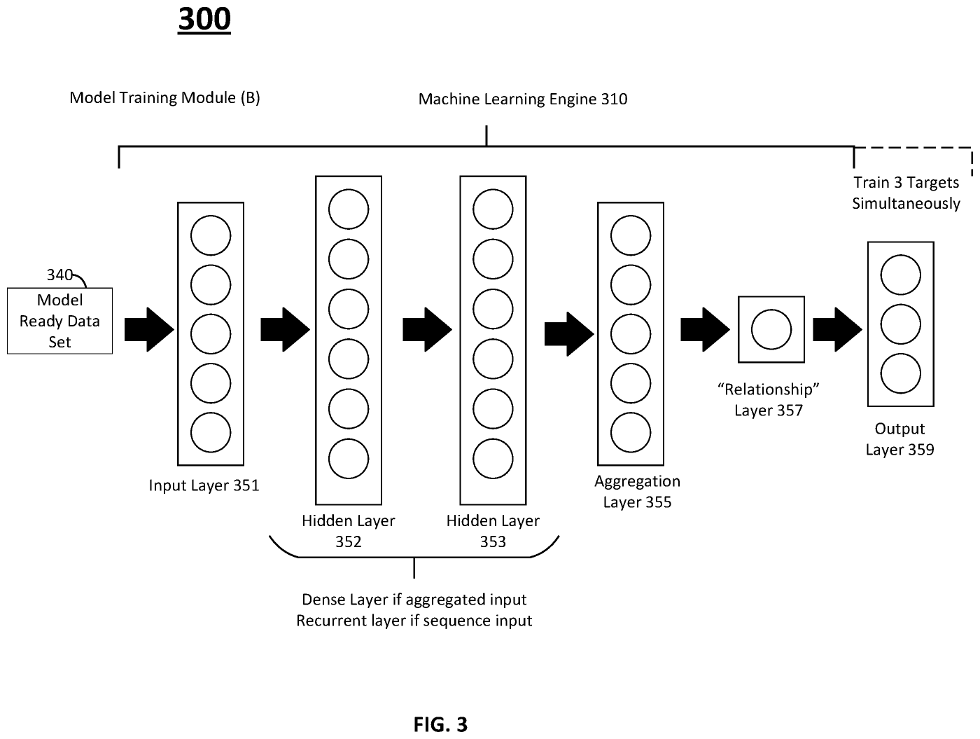

The model-ready data set 240 may be passed within the association quantification circuitry to a model training module as shown in FIG. 3. FIG. 3 illustrates an example of a machine learning process that utilizes the quantified association of a user with the enterprise based on the data input from the example of FIG. 2.

The model training module 300 may include the machine learning engine 310. The machine learning engine 310 may be implemented as a neural network, which may include an input layer 351, a number of hidden layers such as 352 and 353, an aggregation layer 355, a relationship layer 357 and an output layer 359. In an example, the machine learning engine 310 may implement a single model that is trained on multiple target services, such as default risk, marketing response, loan valuation, or the like, at the output layer 359. A unique value representative of a user's relationship depth may be extracted from the relationship layer 357. By selecting more than one target service model upon which to train the single model implemented by machine learning engine 310, a relationship depth value that is more broadly representative of a user's relationship depth with the enterprise may be generated. In an example, the output layer 359 includes target service models that may be selected based on the anticipated influence of each target service may have on a user's relationship depth with the enterprise. In other examples, target service models of the most frequently used services may be selected to determine an influence on a user's relationship depth with the enterprise.

The input layer 351 may use variables created by the system, such as 100 of FIG. 1 or 200 of FIG. 2 and may or may not include all the variables associated with a user. The model-ready data set 340, which may be the model data set 240 of FIG. 2, is input into the machine learning engine 310.

In the hidden layers 352 and 353, the initial variables from the input layer 351 are converted into intermediate variables. The intermediate variables may not have immediate intuitive value but are merely transformed. The hidden layers 352 and 353 may also be referred to as a dense layer, if the input is aggregated, or a recurrent layer if the input is in sequence.

The aggregation layer 355 may collect the outputs from the various outputs of the hidden layer 353 and further transform the intermediate variables from the hidden layers into a more intuitive form of the data that permits operation of the neural network on the data.

The relationship layer 357 may produce a variable that is based on the fitting process of the neural network with reference to the one or more target services of output layer 359. The output from the relationship layer 357 may be referred to as a relationship depth value and may be similar in context to a credit score or mortgage score. For example, the relationship depth value may be a quantification of the user's relationship with the enterprise based on the particular target service selected at output player 359. The relationship depth value may be a value, or a score, that may be scaled from high to low. For example, relationship depth values that are lower on the scale may indicate a weaker relationship between the enterprise user and the enterprise, while a higher score represents a stronger relationship between the enterprise user and the enterprise. The relative relationship depth value may, for example, have a value range such as 0.00-1.00, 1-999, 1-10 or the like, that may be generalized to any service offered by an enterprise. For any target service, such as marketing strategy or the like, a target service model may be trained so the enterprise may evaluate the effect of the relationship depth value on the target service. The relationship depth value may be used as an input to a target service model for use in purposes other than training the respective model. For example, the target service model may use the relationship depth value to determine a user's likelihood that the target service may be used by the user or the like. Based on a result of the processing, the system may generate a relative relationship depth value for the enterprise user, wherein the relative relationship depth value quantifies a relationship of the enterprise user with the enterprise.

The output layer 359 may output a target value relevant to any target service or other service that has a functional relationship to the relative relationship depth value output from the relationship layer 357. In an example, the output layer 359 may have multiple target service models that, in some examples, receive user data and output a respective target value from each target service model based on the training of machine learning engine 310 on multiple target services, such as loan default risk, marketing responses, loan valuation or the like. In an example, the selected multiple target service models may be of interest to the enterprise to better understand the respective selected target services influence on a depth, or strength, of the relationship between the enterprise and the enterprise user. In another example, the relationship depth value maybe but one parameter used to train a selected target service model. For example, in addition to the relationship depth value from the relationship layer 357, the selected target service model may also receive some or all the model ready data set 340 to further train the selected target service model.

An alternative approach may include a customized relationship depth value for several target service models. For example, a relationship depth value may be specific to customer risk or valuation of customer interaction. In an alternative example, the sum of the output of all three, or more, target services may be used to further refine the relationship depth value.

In one example, the output layer 359 has at least three targets service models. In other examples, the output layer may have only one target, or it may have tens of targets. Examples of targets may include marketing response (e.g., a probability of a person responding to a marketing request), but also loan default risk or loan valuation and many others. A target service model that is related to the target service and models the services provided by a respective service provider may utilize the relative relationship depth value as an input.

In some examples, the results of the output layer 359 may be used as a validation of the depth of relationship value. For example, another system (not shown) may take the outputs of the simultaneously-trained target models from the output layer 359 and apply a validation function across the simultaneously-trained target models. The output of the validation function may be used to determine whether the depth of relationship value is accurate. Alternatively, the relationship depth value can be validated by existing business logic to see if the relationship depth value affects an enterprise's interaction with customers as expected.

In an alternative example, the model ready data set (e.g., the enterprise wide data for a particular customer) may be input into each of the trained target models of the output layer 359, the output of those models may include a value associated with the target variable (as it is trained to do). In addition, a value may be extracted from a latent layer of the respective model (before the model output) of each of the trained models. Each value extracted from the latent layer of each respective model may be evaluated to generate a new metric—a relationship depth value relevant to the respective model. For example, one of the respective models that is being trained may be a marketing model that provides an indication of a customer's response to marketing products, and the relationship score may indicate the depth of a user's relationship with the marketing products (e.g., responds to solicitation emails, answers telephone calls or the like). A processor implementing the machine learning engine 310 may be operable to extract the latent layer from training the model on marketing response target and define the latent layer as marketing-specific relationship score. Similarly, we can obtain other specific relationship depth values other service models, such as risk-specific relationship score. Once specific relationship depth values are generated, they can be used individually for specific purposes, or a new aggregation model can be trained on the enterprise's definition of overall relationship depths to generate an overall relationship depth value.

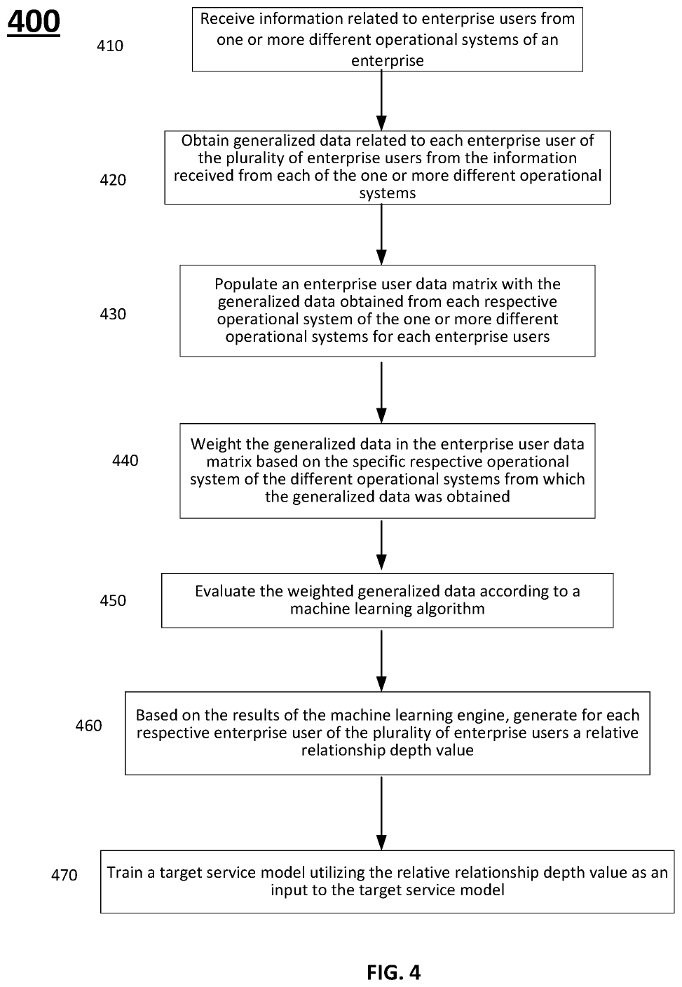

It may be helpful to explain the examples of FIGS. 1-3 with reference to a process flowchart that includes some of the steps described with respect to the features of FIGS. 1-3. FIG. 4 illustrates an example of a process flowchart for quantifying an association of a user with an enterprise. The process 400 of quantifying an association or a depth of a relationship of a user with an enterprise includes several steps. For example, association quantification processing component may receive from one or more of different operational systems (e.g., operational system/service provider 10-40, activities data source 50 and other data sources 60 and external financial data source 70) of an enterprise information related to enterprise users (410). For example, the association quantification processing component may be configured to output a request to a respective operational system of the many operational systems for information related to enterprise users, and in response to the request, may receive information related to the enterprise users. The association quantification processing component may obtain generalized data related to each enterprise user from the information received from each of the one or more different operational systems of the number of enterprise users (420). An enterprise user data matrix may be populated with the generalized data obtained from each respective operational system of the one or more different operational systems for each of the enterprise users of the numerous enterprise users.

At 430, an enterprise user data matrix may be populated with the generalized data obtained from each respective operational system of the one or more different operational systems for each of the enterprise users. For example, each of the enterprise users may be represented by a vector of generalized data in the enterprise user data matrix. The generalized data extracted from the enterprise user-related information received from each respective operational system of the operational systems may be weighted (440). For example, a machine learning engine coupled to the association quantification processing component may be configured to weight the generalized data in the enterprise user data matrix based on the respective operational system of the different operational systems from which the generalized data was obtained. For example, weightings of the generalized data obtained from the operational system/data source 10 may be different from the weightings of the generalized data obtained from the operational system/data source 40.

In some examples, additional information may be received from additional data sources, such as the external financial data source 70. The additional information may be an expanded snapshot over time of the services provided by a respective one of the one or more different operational systems. For example, the additional information may include data from different time periods or events with respect to the enterprise user's interaction with or use of services provided by the enterprise. In response to receiving the additional information, the weightings of the generalized data, for example, from operational system/data source 10-40 may or may not be updated based on additional information obtained with respect to each enterprise user of the plurality of enterprise users for the additional data sources.

Upon weighting the generalized data, the weighted generalized data from each operational system of the plurality of operational systems may be processed using a machine learning engine (450). In an example, the machine learning engine may process the weighted generalized data using a machine learning algorithm, such as a neural network, a linear regression, logic regression, linear discriminant analysis or the like. The processing by the machine learning engine may, for example, identify structural and temporal patterns across each respective operational system of the enterprise in the generalized data provided by each of the different operational systems. The machine learning engine may perform additional levels of processing of the generalized data based on the identified structural and temporal patterns for each enterprise user of the plurality of enterprise users.

At 460, the association quantification processing component may, based on the results of the machine learning engine, generate for each respective enterprise a relative relationship depth value. The relative relationship depth value may quantify the depth of the relative relationship of a user with the enterprise. The relative relationship depth value may be determined by application of machine learning engine, such as machine learning engine 310 of FIG. 3. For example, the output of the relationship layer of the machine learning engine 310 may be used by the association quantification processing component to generate a relative relationship depth value. The relative relationship depth value may quantify a relationship of the respective enterprise user of the plurality of enterprise users with the enterprise.

In some examples, the relative relationship depth value may be used to determine an enterprise user response score, which is a value within a range that indicates an expected user response to an initiative for the respective service to be provided by a target service provider based on the depth of the relative relationship of the user with the enterprise. In an example, the association quantification processing component may, for example, be configured to select a target enterprise user evaluation process from a plurality of enterprise user evaluation processes for training or updating (e.g., training updates). Returning to FIG. 4 at 470, machine learning engine 310 may include an output layer that is trained on multiple targets. In an example, the multiple targets may be selected such that the output extracted from the relationship layer may be indicative of a user's relationship with an enterprise. In some embodiments, the relative relationship depth value may be used as part of a training of other distinct target service models. For example, a new target service model may be trained utilizing the relative relationship depth value as an input to the target service model. The trained target service model may generate an anticipated enterprise user response score related to the target service. In some examples, other target service models may be identified for updated training based on the relative relationship depth value of the enterprise user. If the selected target service model for the target enterprise user evaluation process has been previously trained, the selected target enterprise user evaluation process may be supplemented based on the trained target service model with the relative relationship depth value of the enterprise user.

The system, such as enterprise relationship system 180 of FIG. 1, may evaluate the relationship for each respective enterprise user that has generalized data in the enterprise user data matrix. For example, the association quantification processing component may evaluate the generalized data and output an enterprise response score relative to services that are modeled by the target service model. In a further example, the system may update the identified enterprise target client evaluation of the enterprise user using the relative relationship depth value generated for the enterprise user. Upon completion of the evaluation, the system may output an updated evaluation result of the enterprise target client evaluation of the respective enterprise user. Alternatively, the system may output a revised relative relationship depth value, which quantifies a contribution of the information from the external data source to the target or other target service model. In this example, an enterprise target may be a client attribute that is quantified by using the relative relationship depth value with respect to services provided by the entire enterprise. An example of a client attribute may be, for example, consistent on-time payer of bills, inconsistent payer of bills, high or low creditworthiness, number and length of time of banking products ownership, responsiveness to new products or technology advances (e.g., mobile banking, website activities, or the like), or similar attributes beyond demographic information. For example, a client attribute value may be output from the machine learning engine. The client attribute value may quantify the client attribute with respect to the enterprise user.

An additional process step may include generating additional weightings for use by the machine learning engine based on data received from an external data source for each respective enterprise user of the plurality of enterprise users having generalized data in the enterprise user data matrix. After the additional weightings are generated, the generated additional weightings are applied to the generalized data. The weighted external generalized data and the relative relationship depth value may be input into the machine learning engine. Based on results of the machine learning engine in response to the input of the weighted generalized external data and the relative relationship depth value, a client attribute value may be output that quantifies the client attribute with respect to the enterprise user.

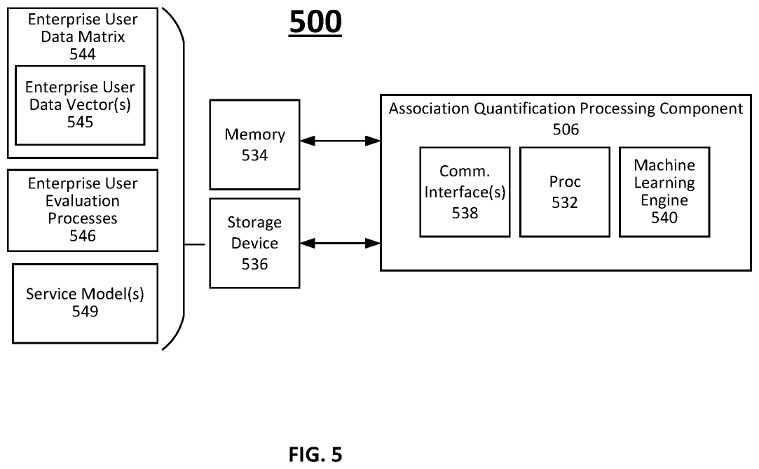

FIG. 5 illustrates an example of a computing architecture suitable for implementing various examples as described in the examples of FIGS. 1-4.

The computing architecture 500 may include several components, such as the association quantification processing component 506, memory 534 and storage device 536. The association quantification processing component 506 may include several components that may perform one or more operations as discussed herein. The association quantification processing component 506 includes one or more processor(s) 532, one or more communication (comm.) interface(s) 538, and a machine learning engine 540, and be coupled to memory 534 and storage device 536 via, for example, one or more of the communication interfaces 538.

In examples, the association quantification processing component 506 may be a processing system that includes one or more servers or computing devices that are interconnected via one or more network links, e.g., wired, wireless, fiber, etc. In some instances, the transaction services system may be a distributed computing system. Each of the servers may include one or more processor(s) 532, which may include one or more processing cores to process information and data. Moreover, the one or more processors 532 can include one or more processing devices, such as a microprocessor manufactured by Intel™, AMD™, or any of various processors. The disclosed examples are not limited to any type of processor(s).

Memory 534 can include one or more memory (volatile or non-volatile) devices configured to store instructions used by the one or more processors 532 to perform one or more operations consistent with the disclosed examples. For example, memory 534 can be configured with one or more software instructions, such as programs that can perform one or more operations when executed by the one or more processors 532.

As mentioned, the association quantification processing component 506 includes one or more processors 532, memory 534, storage device 536, interfaces 538, and machine learning engine 540. The association quantification processing component 506 may be a processing system that includes one or more servers or computing devices that are interconnected via one or more networking links, e.g., wired, wireless, fiber, etc. and is capable of processing information and data from the service provider data sources, activities and external data sources. In some instances, the association quantification processing component 506 may also be a distributed computing system. Each of the servers may include one or more processor(s) 532, which may include one or more processing cores to process information and data. The association quantification processing component 506 also includes memory 534, which may be like and/or the same as memory 534. Memory 534 can include one or more memory (volatile or non-volatile) devices configured to store instructions used by the one or more processors 532 to perform one or more operations consistent with the disclosed examples. For example, the memory 534 may store programming code and other computer-readable code that enables the association quantification processing component 506 to perform operations and functions as described with reference to the foregoing examples as well as other operations and functions.

In examples, the association quantification processing component 506 may include one or more storage devices 536. The storage devices 536 may include hard disc drives (HDDs), flash memory devices, optical storage devices, floppy storage devices, etc. In some instances, the storage devices 536 may include cloud-based storage devices that may be accessed via a network interface. In some examples, the storage device 536 may be configured to store one or more data structures and/or a distributed database system to store information and data. For example, the storage device 536 may store the enterprise user data matrix 544, enterprise user evaluation processes 546 and service models 549. The enterprise user data matrix 544 may include enterprise user data vectors 545 for each enterprise user whose enterprise information and generalized data are being used in quantifying a relationship depth. The enterprise user evaluation processes 546 may be a number of enterprise user evaluation processes that may be supplemented based on the output of a service model trained with the relative relationship depth value of the enterprise user.

The association quantification processing component 506 includes one or more interfaces 538. The one or more interfaces 538 can include one or more digital and/or analog communication devices that allow the association quantification processing component 506 communicate with other machines and devices, such servers and systems related to the services provided by the enterprise service providers. The one or more interfaces 538 may communicate via any type of connection, e.g., wired, wireless, optical, and so forth. These interfaces 538 may include network adapters and/or modems to communicate with the systems and/servers of the enterprise service providers. The examples are not limited in this manner.

The association quantification processing component 506 may also include a machine learning engine 540. The machine learning engine 540 may include processing component, logic circuits, field programmable gate arrays or the like that is configured to implement a machine learning algorithm such as those described above with reference to the examples of FIGS. 1-4.

Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

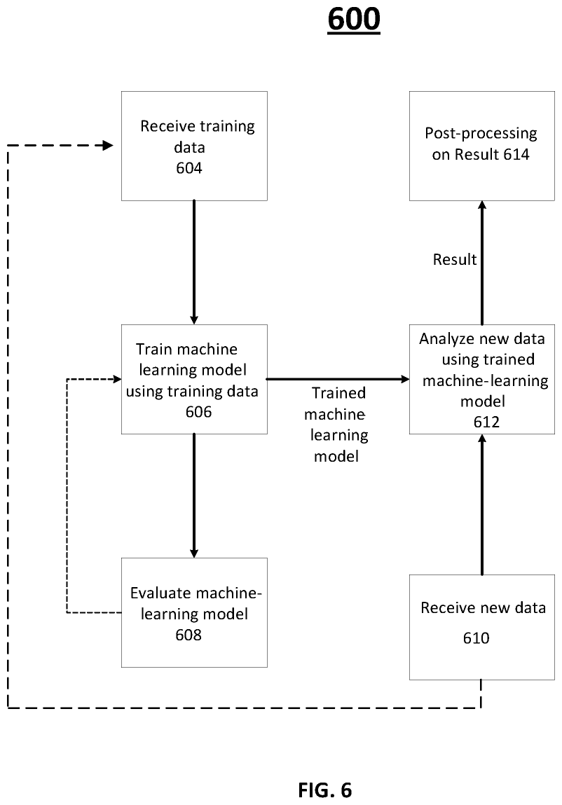

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to FIG. 6, which is a flowchart of an example of a process for training and using a machine-learning model according to some aspects of the foregoing examples.

The process 600 includes several steps, for example, in block 604, training data is received. In some examples, the training data is received from a remote database or a local database, constructed from various subsets of data, or input by a user. The training data can be used in its raw form for training a machine-learning model or preprocessed into another form, which can then be used for training the machine-learning model. For example, the raw form of the training data can be smoothed, truncated, aggregated, clustered, or otherwise manipulated into another form, which can then be used for training the machine-learning model. In examples, the training data may include transaction information, historical transaction information, and/or information relating to the transaction. The transaction information may be for a general population and/or specific to a user and user account in a financial institutional database system.

In block 606, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model must find structure in the inputs on its own. In semi-supervised training, only some of the inputs in the training data are correlated to desired outputs.

In block 608, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, e.g., the current transaction information, the machine-learning model may have a high degree of accuracy. Otherwise, the machine-learning model may have a low degree of accuracy. The 90% number is an example only. A realistic and desirable accuracy percentage is dependent on the problem and the data.

In some examples, if the machine-learning model has an inadequate degree of accuracy for a task, the process can return to block 606, where the machine-learning model can be further trained using additional training data or otherwise modified to improve accuracy. If the machine-learning model has an adequate degree of accuracy for the task, the process can continue to block 610.

In block 610, new data is received. In some examples, the new data is received from a remote database or a local database, constructed from various subsets of data, or input by a user. The new data may be unknown to the machine-learning model. For example, the machine-learning model may not have previously processed or analyzed the new data. In some examples, the new may be provided to the process at 604 for use as training data.

In block 612, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 614, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in examples.

At least one computer-readable storage medium may include instructions that, when executed, cause a system to perform any of the computer-implemented methods described herein.

Some examples may be described using the expression “one example” or “an example” along with their derivatives. These terms mean that a particular feature, structure, or characteristic described in connection with the example is included in at least one example. The appearances of the phrase “in one example” in various places in the specification are not necessarily all referring to the same example. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A process is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more examples. Rather, the operations are machine operations.

Some examples may be described using the expression “coupled” and “connected” along with their derivatives. These terms are not necessarily intended as synonyms for each other. For example, some examples may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

As used in this application, the terms “system” and “component” are intended to refer to a computer-related entity, either hardware, a combination of hardware and software, software, or software in execution, examples of which are provided by the examples in FIGS. 1-5. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server or processor and the server or processor can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Various examples also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, various features are grouped together in a single example for streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications, and variations that fall within the spirit and scope of the appended claims.

1-7. (canceled)

8. A method, comprising:
receiving, by an association quantification processing component coupled to one or more different operational systems of an enterprise, from the one or more different operational systems of the enterprise, information related to a plurality of enterprise users, wherein the information includes customer behavior information, account performance information or context information;
obtaining, from the information received from each operational system of the one or more different operational systems, generalized data related to each enterprise user of the plurality of enterprise users;
populating an enterprise user data matrix with the generalized data obtained from each respective operational system of the one or more different operational systems for each enterprise user of the plurality of enterprise users;
training a machine learning algorithm executed by a machine learning engine of the association quantification processing component utilizing information in the enterprise user data matrix;
weighting, by the trained machine learning algorithm executed by the machine learning engine, the generalized data in the enterprise user data matrix of the respective operational system of the one or more different operational systems from which the generalized data was obtained;
processing, by the machine learning engine, the weighted generalized data according to the trained machine learning algorithm, wherein the machine learning algorithm includes a relationship layer;
based on an output from the relationship layer, generating for each respective enterprise user of the plurality of enterprise users a relative relationship depth value, wherein the relative relationship depth value is a score that quantifies a relationship of the respective enterprise user of the plurality of enterprise users with the enterprise;
training a target service model utilizing the relative relationship depth value as an input to the target service model; and
generating by the trained target service model an enterprise user response score related to a specific target service modeled by the trained target service model.

9. The method of claim 8, further comprising:
updating weightings of the generalized data based on additional information obtained with respect to each enterprise user of the plurality of enterprise users, wherein the additional information is an expanded snapshot over time of services provided by a respective one of the one or more different operational systems to each respective enterprise user of the plurality of enterprise users.

10. The method of claim 8, further comprising:
identifying, by the machine learning engine, structural and temporal patterns across each respective operational system of the enterprise in the generalized data obtained from each of the different operational systems; and
performing, by the machine learning engine, additional levels of processing of the generalized data based on the identified structural and temporal patterns for each enterprise user of the plurality of enterprise users.

11. The method of claim 8, further comprising:
receiving information from an external data source, wherein the information received from the external data source includes commercial data relevant to the enterprise;
processing the commercial data received from the external data source for input into the machine learning engine as generalized external data;
weighting the generalized external data; and
inputting the weighted generalized external data into the machine learning engine during an evaluation of the weighted generalized data.

12. The method of claim 8, further comprising:
identifying another target service model for updated training based on the relative relationship depth value of the respective enterprise user; and
for each respective enterprise user of the plurality of enterprise users having generalized data in the enterprise user data matrix:
updating an enterprise user response score for the identified other target service model.

13. The method of claim 12, wherein updating the enterprise user response score for the identified other target service model further comprises:
for each respective enterprise user of the plurality of enterprise users having generalized data in the enterprise user data matrix:
generating additional weightings of the generalized data for use by the machine learning engine based on data received from an external data source;
inputting the generated additional weightings of the generalized data and the relative relationship depth value to the machine learning engine;
based on results of the generated additional weightings and relative relationship depth value input into the machine learning engine, outputting a client attribute value that quantifies the client attribute with respect to the respective enterprise user; and
training identified other target service model utilizing the client attribute value as an input, wherein the trained, identified other target service model generates an enterprise user response score related to s-another target service modeled by the other target service model.

14-20. (canceled)

21. An apparatus, comprising:
a communication interface that is communicatively coupled to one or more different operational systems of an enterprise that provide different services to an enterprise user;
a memory storing programming code; and
an association quantification processing component comprising a processor and a machine learning engine coupled to the memory, wherein the association quantification processing component is operable to execute the stored programming code, that when executed causes the association quantification processing component to perform functions, including functions to:
receive, by an association quantification processing component coupled to one or more different operational systems of an enterprise, from each of the one or more different operational systems of the enterprise, information related to a plurality of enterprise users, wherein the information includes customer behavior information, account performance information or context information;
obtain, from the information received from each operational system of the one or more different operational systems, generalized data related to each enterprise user of the plurality of enterprise users;
populate an enterprise user data matrix with the generalized data obtained from each respective operational system of the one or more different operational systems for each of the enterprise users of the plurality of enterprise users;
train a machine learning algorithm executed by a machine learning engine of the association quantification processing component, utilizing information in the enterprise user data matrix;
weight, by the trained machine learning algorithm executed by the machine learning engine, the generalized data in the enterprise user data matrix based the respective operational system of the one or more different operational systems from which the generalized data was obtained;
process, by the machine learning engine, the weighted generalized data according to the trained machine learning algorithm, wherein the machine learning algorithm includes a relationship layer;
based on an output from the relationship layer, generate for each respective enterprise user of the plurality of enterprise users a relative relationship depth value, wherein the relative relationship depth value is a score that quantifies a relationship of the respective enterprise user of the plurality of enterprise users with the enterprise;
train a target service model utilizing the relative relationship depth value as an input to the target service model; and
generate by the trained target service model an enterprise user response score related to a specific target service modeled by the trained target service model.

22. The apparatus of claim 21, wherein the memory further comprises programming code that causes the association quantification processing component to perform further functions, including functions to:
updating weightings of the generalized data based on additional information obtained with respect to each enterprise user of the plurality of enterprise users, wherein the additional information is an expanded snapshot over time of services provided by a respective one of the one or more different operational systems to each respective enterprise user of the plurality of enterprise users.

23. The apparatus of claim 21, wherein the memory further comprises programming code that causes the association quantification processing component to perform further functions, including functions to:
identifying, by the machine learning engine, structural and temporal patterns across each respective operational system of the enterprise in the generalized data obtained from each of the one or more different operational systems; and
performing, by the machine learning engine, additional levels of processing of the generalized data based on the identified structural and temporal patterns for each enterprise user of the plurality of enterprise users.

24. The apparatus of claim 21, wherein the memory further comprises programming code that causes the association quantification processing component to perform further functions, including functions to:
receiving information from an external data source, wherein the received external data source information includes commercial data relevant to the enterprise;
processing the commercial data received from the external data source for input into the machine learning engine as generalized external data;
weighting the generalized external data; and
inputting the weighted generalized external data into the machine learning engine during an evaluation of the weighted generalized data.

25. The apparatus of claim 21, wherein the memory further comprises programming code that causes the association quantification processing component to perform further functions, including functions to:
identifying another target service model for updated training based on the relative relationship depth value of the respective enterprise user; and
for each respective enterprise user of the plurality of enterprise users having generalized data in the enterprise user data matrix:
updating an enterprise user response score for the identified other target service model.

26. The apparatus of claim 25, wherein the memory further comprises programming code that causes the association quantification processing component, when updating the enterprise user response score for the identified other target service model, to perform further functions, including functions to:
for each respective enterprise user of the plurality of enterprise users having generalized data in the enterprise user data matrix:
generating additional weightings of the generalized data for use by the machine learning engine based on data received from an external data source;
inputting the generated additional weightings of the generalized data and the relative relationship depth value to the machine learning engine;
based on results of the generated additional weightings and relative relationship depth value input into the machine learning engine, outputting a client attribute value that quantifies the client attribute with respect to the enterprise user; and
training the identified other target service model utilizing the client attribute value as an input, wherein the trained other target service model generates an enterprise user response score related to a target service modeled by the other target service model.

27. A system, comprising:
a memory storing programming code;
association quantification processing component, wherein the association quantification processing component, upon execution of the programming code stored in the memory, is operable to perform different functions; and
a plurality of enterprise operational systems, wherein each of the plurality of enterprise operational systems provides a service to the plurality of enterprise users, wherein:
the memory, the association quantification processing component and the plurality of enterprise operational systems are coupled in a network via a network bus, and
upon execution of the programming code stored in the memory, the association quantification processing component is operable to:
receive, by an association quantification processing component coupled to one or more different operational systems of an enterprise, from the one or more different operational systems of the enterprise, information related to the plurality of enterprise users, wherein the information includes customer behavior information, account performance information or context information;
obtain, from the information received from each operational system of the one or more different operational systems, generalized data related to each enterprise user of the plurality of enterprise users;
populate an enterprise user data matrix with the generalized data obtained from each respective operational system of the one or more different operational systems for each of the enterprise users of the plurality of enterprise users;
train a machine learning algorithm executed by a machine learning engine of the association quantification processing component utilizing information in the enterprise user data matrix;
weight, by the trained machine learning algorithm executed by the machine learning engine, the generalized data in the enterprise user data matrix based the respective operational system of the one or more different operational systems from which the generalized data was obtained;
process, by the machine learning engine, the weighted generalized data according to the trained machine learning algorithm, wherein the machine learning algorithm includes a relationship layer;
based on an output from the relationship layer, generate for each respective enterprise user of the plurality of enterprise users a relative relationship depth value, wherein the relative relationship depth value is a score that quantifies a relationship of the respective enterprise user of the plurality of enterprise users with the enterprise;
train a target service model utilizing the relative relationship depth value as an input to the target service model; and
generate by the trained target service model an enterprise user response score related to a specific target service modeled by the trained target service model.

28. The system of claim 27, the memory further comprising programming code that causes the association quantification processing component to perform further functions, including further functions to:
update weightings of the generalized data based on additional information obtained with respect to each enterprise user of the plurality of enterprise users, wherein the additional information is an expanded snapshot over time of services provided by a respective one of the one or more different operational systems to each respective enterprise user of the plurality of enterprise users.

29. The system of claim 27, the memory further comprising programming code that causes the association quantification processing component to perform further functions, including functions to:
identify, by the machine learning engine, structural and temporal patterns across each respective operational system of the enterprise in the generalized data obtained from each of the different operational systems; and
perform, by the machine learning engine, additional levels of processing of the generalized data based on the identified structural and temporal patterns for each enterprise user of the plurality of enterprise users.

30. The system of claim 27, the memory further comprising programming code that causes the association quantification processing component to perform further functions, including functions to:
receive information from an external data source, wherein the received external data source information includes commercial data relevant to the enterprise;
process the commercial data received from the external data source for input into the machine learning engine as generalized external data;
weight the generalized external data; and
input the weighted generalized external data into the machine learning engine during an evaluation of the weighted generalized data.

31. The system of claim 27, the memory further comprising programming code that causes the association quantification processing component to perform further functions, including functions to:
identify another target service model for updated training based on the relative relationship depth value of the enterprise user; and
for each respective enterprise user of the plurality of enterprise users having generalized data in the enterprise user data matrix:
update an enterprise user response score for the identified other target service model.

32. The system of claim 31, the memory further comprising programming code that causes the association quantification processing component, when updating an enterprise user response score for the identified other target service model, to perform further functions, including functions to:
for each respective enterprise user of the plurality of enterprise users having generalized data in the enterprise user data matrix:
generate additional weightings of the generalized data for use by the machine learning engine based on data received from an external data source;
input the generated additional weightings of the generalized data and the relative relationship depth value to the machine learning engine;
based on results of the generated additional weightings and relative relationship depth value input into the machine learning engine, output a client attribute value that quantifies the client attribute with respect to the enterprise user;
train the identified other target service model utilizing the client attribute value as an input, wherein the trained other target service model generates an enterprise user response score related to a target service modeled by the other target service model.
